(19) United States
(12) Patent Application Publication
(10) Pub. No.: US 2025/0121806 A1
(43) Pub. Date: Apr. 17, 2025

(54) ELECTRONIC CONTROL UNIT FOR ELECTRIC BRAKE SYSTEM, AND ELECTRIC BRAKE SYSTEM AND VEHICLE INCLUDING SAME

(71) Applicant: HL MANDO CORPORATION, Pyeongtaek-si (KR)

(72) Inventors: Kawnseek KIM, Suwon-si (KR); Heechul JUNG, Suwon-si (KR)

(21) Appl. No.: 18/898,296

(22) Filed: Sep. 26, 2024

(30) Foreign Application Priority Data
Oct. 11, 2023 (KR) 10-2023-0135262
Apr. 8, 2024 (KR) 10-2024-0047263

(51) Int. Cl. B60T 8/171; B60T 13/58; B60T 13/68; H02P 5/74

(52) U.S. Cl. CPC B60T 8/171; B60T 13/588; B60T 13/686; H02P 5/74; B60T 2220/04; B60T 2240/00

(57) ABSTRACT

An electronic control unit (ECU) of an electric brake system and a brake system including same are described. The ECU of an electric brake system according to an embodiment of the present disclosure is an ECU including a first motor operating to generate a braking pressure in a vehicle, a valve adjusting a braking hydraulic pressure according to the operation of the first motor, a second motor operating to provide a parking braking force for the vehicle, and a driver supplying AC power for the operation of the second motor, and includes a converter converting DC power of a first voltage into DC power of a second voltage that is lower than the first voltage; an inverter inverting the DC power of the first voltage into AC power and supplying the AC power to the first motor; and a controller receiving the DC power of the second voltage and controlling at least one of the inverter, the valve, and the driver.

### CROSS-REFERENCE TO RELATED APPLICATION

This application claims priority to and the benefit of Korean Patent Application No. 10-2023-0135262, filed on Oct. 11, 2023, and No. 10-2024-0047263, filed on Apr. 8, 2024, the disclosures of which are incorporated herein by reference in their entirety.

### BACKGROUND

### Technical Field

The present disclosure relates to an electric brake system technology, more specifically, the present disclosure relates to a power connection structure technology of an electronic control unit (ECU) in an electric brake system for generating a braking force necessary for deceleration or stop of a vehicle.

### Description of the Related Art

Recently, in relation to brakes of vehicles, an electric brake has been widely used in which the amount of brake pedal operation of a driver is transmitted as an electrical signal to drive a motor and a braking pressure is generated according to the driving of the motor. Such an electric brake can be configured to perform braking without intervention of the driver through autonomous control and driving of the motor, and thus is highly valuable in realizing autonomous driving technology.

In the related art, a 12V battery is generally used as a power source of electrical and electronic equipment in vehicles. In this situation, a circuit for driving and controlling the electric brake is also designed for 12V.

Meanwhile, electric vehicles driven by the motor replacing an internal combustion engine are becoming widely available, and electric vehicles include the electric brake. In particular, the electric vehicles are equipped with batteries that provide a high-voltage (e.g., 48V) than before as a driving power source. Accordingly, in order to improve efficiency, it is considered to adopt the high-voltage battery as the power source of the electric brake mounted on electric vehicles.

### BRIEF SUMMARY

The inventors of the present disclosure have appreciated that when the power source for the control and driving circuits of the electric brake is replaced with the high-voltage battery, the development and mass production of new circuit elements may be required, which may cause problems in terms of economic efficiency. In addition, in the case of driving a motor that generates braking hydraulic pressure in the electric brake, the high-voltage power source is effective, but in the case of control-related circuits other than this, a low voltage power source is more efficient.

Various embodiments of the present disclosure address the technical problems in the related art, including the above-identified problems.

Various embodiments of the present disclosure provide a power connection technology that increases or maximizes the efficiency of power source use and the economic feasibility of circuit configuration for the high-voltage power source supplied in the ECU of the brake system.

However, the problem to be solved by the present disclosure is not limited to the above-mentioned problem, and other problems not mentioned can be clearly understood by a person with ordinary skills in the art to which the present disclosure belongs from the following description.

According to an embodiment of the present disclosure, an electronic control unit (ECU) may include a first motor operating to generate a braking pressure in a vehicle, a valve adjusting a braking hydraulic pressure according to the operation of the first motor, a second motor operating to provide a parking braking force for the vehicle, and a driver supplying AC power for the operation of the second motor, wherein the ECU include a converter converting DC power of a first voltage into DC power of a second voltage that is lower than the first voltage; an inverter inverting the DC power of the first voltage into AC power and supplying the AC power to the first motor; and a controller receiving the DC power of the second voltage and controlling at least one of the inverter, the valve, and the driver. The ECU further comprises a first power line supplying the DC power of the first voltage or a second power line supplying the DC power of the second voltage to at least one of the driver and the valve.

The driver and the valve may be connected to the second power line and operate by receiving the DC power of the second voltage.

The driver may be connected to the first power line and operate by receiving the DC power of the first voltage, and the valve may be connected to the second power line and operate by receiving the DC power of the second voltage.

The valve may be connected to the first power line and operate by receiving the DC power of the first voltage, and the driver may be connected to the second power line and operate by receiving the DC power of the second voltage.

The driver and the valve may be connected to the first power line and operate by receiving the DC power of the first voltage.

The inverter and the driver each may include a plurality of switching elements for performing inversion to AC power, and the inverter may include a larger number of switching elements than the driver, and the AC voltage transmitted to the first motor through the inverter may have relatively more types of peak voltage sizes than the AC voltage transmitted to the second motor through the driver.

The electric brake system may further include a pedal displacement sensor, a pressure sensor, and a wheel speed sensor. The controller may perform control on the inverter using pedal displacement information received from the pedal displacement sensor, braking pressure information received from the pressure sensor, and wheel speed information received from the wheel speed sensor, respectively.

According to an embodiment of the present disclosure, an electric brake system may include a power source supplying DC power of a first voltage; a first motor operating to generate a braking pressure in a vehicle; a valve adjusting a braking hydraulic pressure according to the operation of the first motor; a second motor operating to provide a parking braking force for the vehicle; a driver supplying AC power for the operation of the second motor; and an electronic control unit (ECU) controlling the operations of the first and second motors. The ECU may include a converter converting the DC power of the first voltage into DC power of a second voltage that is lower than the first voltage; an inverter inverting the DC power of the first voltage into AC power and supplying the AC power to the first motor; and a controller receiving the DC power of the second voltage and controlling at least one of the inverter, the valve, and the driver. At least one of the driver and the valve may receive the DC power of the first voltage or the DC power of the second voltage and operate.

The vehicle according to an embodiment of the present disclosure includes the electric brake system described above.

The present disclosure configured as described above has an advantage of achieving both the efficiency of power source use and the economic feasibility of circuit configuration for the ECU by adopting the power of the first voltage, which is a high-voltage, as the driving power of the first motor in the ECU of the brake system, and selectively adopting the power of the first voltage or the power of the second voltage, which is lower than the first voltage, as the driving power for the remaining configurations of the ECU.

In particular, as the power connection technology for the first and second voltages is implemented inside the ECU, the wiring for the power is reduced by up to ¼ than the power connection technology for the first and second voltages is implemented outside the ECU, so that the cost reduction effect is great.

The effects obtained by the present disclosure are not limited to the above-described effects, and other effects which are not described herein will be clearly understood by those skilled in the art from the following description.

### BRIEF DESCRIPTION OF THE DRAWINGS

FIG. 1 shows a schematic block diagram of a brake system according to embodiments of the present disclosure.

FIG. 2 shows a more detailed block diagram of the brake system according to a first embodiment of the present disclosure.

FIG. 3 shows a more detailed block diagram of a brake system according to a second embodiment of the present disclosure.

FIG. 4 shows a more detailed block diagram of a brake system according to a third embodiment of the present disclosure.

FIG. 5 shows a more detailed block diagram of a brake system according to a fourth embodiment of the present disclosure.

FIG. 6 shows an example of a circuit of a DC-DC converter.

FIG. 7 shows an example of an additional configuration in which power is supplied through a controller in the brake system according to the embodiments of the present disclosure.

### DETAILED DESCRIPTION

Features and advantages of the present disclosure will become apparent from the following detailed description of the accompanying drawings, and accordingly, those skilled in the art will easily be able to embody the technical ideas of the present disclosure. In addition, in the description of the present disclosure, a detailed description of known techniques related to the present disclosure will be omitted when it is determined that the subject matter of the present disclosure may be unnecessarily obscured.

The terminology used herein is for the purpose of describing embodiments and is not intended to limit the present disclosure. In the present specification, the singular forms “a,” “an” and “the” are intended to include the plural forms as well, unless otherwise specified. In the present specification, the terms “comprise,” “include,” “provided with,” and “have” do not exclude the presence or addition of one or more other components other than the mentioned components.

In the present specification, the terms “or,” “at least one,” and the like may indicate one of the words listed together, or may indicate a combination of two or more. For example, “A or B” and “at least one of A and B” may include one or more of A, one or more of B, or one or more of both A and B.

In the description according to “for example” and the like, the presented information such as the characteristics, variables, or values mentioned may not be exactly consistent, and the embodiments of the present disclosure according to various embodiments of the present disclosure should not be limited by effects such as variations including tolerances, measurement errors, limitations of measurement accuracy, and other commonly known factors.

In the present specification, when an element is described as being “connected to” or “coupled with” another element, it should be understood that the element may be directly connected to or connected to the other element, but other elements may be present in the middle. On the other hand, when an element is described as being “directly connected to” or “directly coupled with” another element, it should be understood that there are no intervening elements.

In the present specification, when an element is described as being “over” or “on top of” another element, it should be understood that the element may be directly engaged or connected to the other element, but other elements may be present in the middle. On the other hand, when an element is described as being “directly on” or “in contact with” another element, it should be understood that there are no intervening elements. Other expressions for describing a relationship between elements, for example, “between” and “directly between” may be interpreted as well.

In the present specification, the terms “first,” “second,” and the like may be used to describe various elements, but the elements should not be limited by the above terms. In addition, the above terms should not be interpreted as being used to limit the order of each element, but may be used to distinguish one element from another. For example, the first component may be referred to as the second component, and similarly, the second component may be referred to as the first component.

Unless otherwise defined, all terms used in the specification may be used in their meanings that can be commonly understood by those skilled in the art to which the present disclosure pertains. Further, terms defined in a commonly used dictionary are not interpreted ideally or excessively unless otherwise clearly defined.

Hereinafter, a preferred embodiment of the present disclosure will be described in detail with reference to the accompanying drawings.

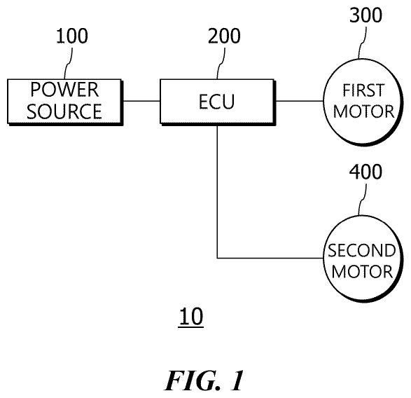

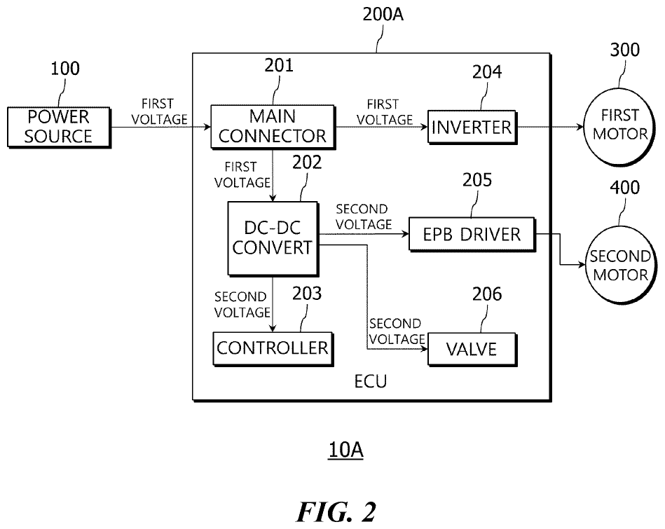

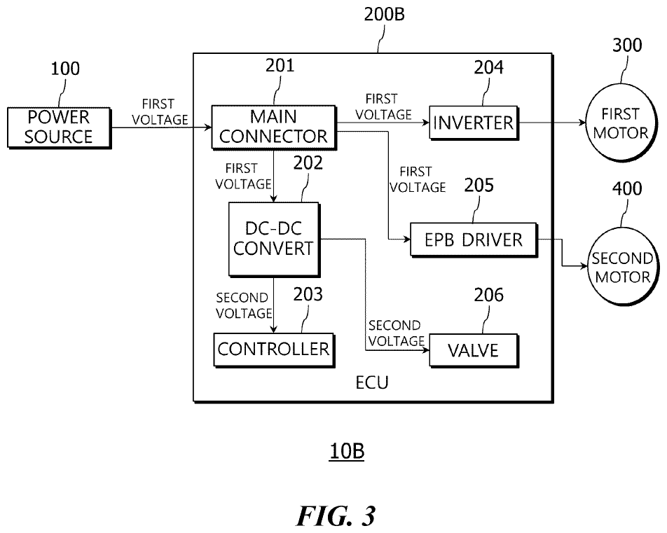

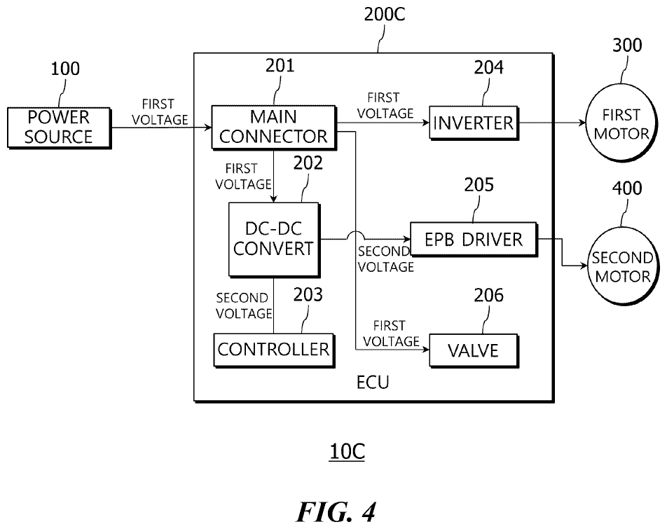

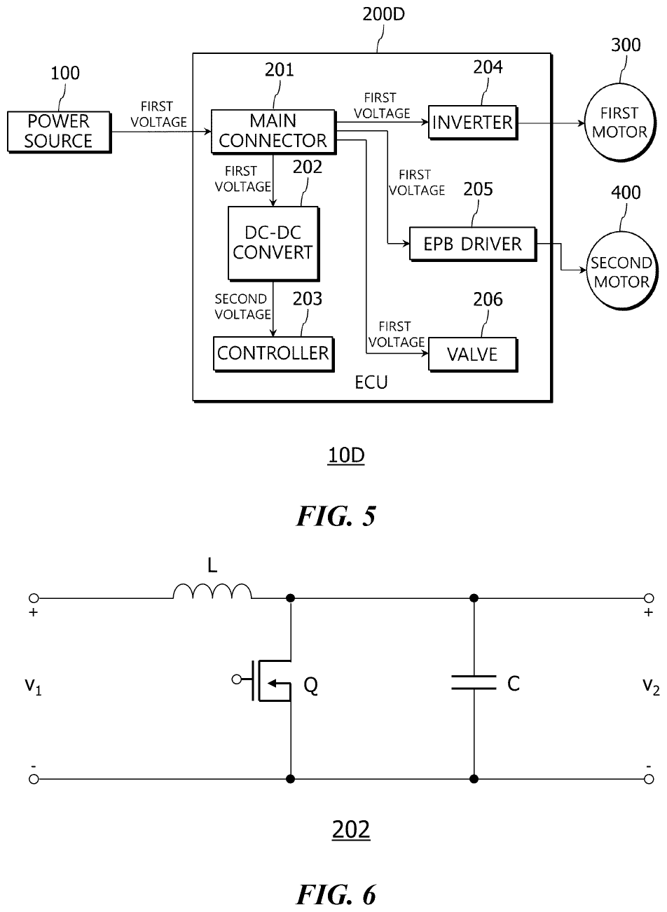

FIG. 1 shows a schematic block diagram of a brake system 10 according to embodiments of the present disclosure. FIG. 2 shows a more detailed block diagram of the brake system 10A according to a first embodiment of the present disclosure, and FIG. 3 shows a more detailed block diagram of a brake system 10B according to a second embodiment of the present disclosure. In addition, FIG. 4 shows a more detailed block diagram of a brake system 10C according to a third embodiment of the present disclosure, and FIG. 5 shows a more detailed block diagram of a brake system 10D according to a fourth embodiment of the present disclosure.

The brake system 10 according to various embodiments of the present disclosure is a system applied to a vehicle, and generates a braking force necessary for deceleration or stop of the vehicle. Referring to FIGS. 1 to 5, this brake system 10 is preferably an electric brake system.

At this time, the electric brake system is a system that converts the force with which the driver presses the brake pedal into an electrical signal for braking instead of a system used in existing vehicles where the driver directly controls the hydraulic pressure of the brake to brake the vehicle. In other words, the electric brake system is a method in which when the driver steps on the pedal, the simulator attached to the pedal converts it into the electrical signal and transmits it to an electronic control unit (ECU) 200, and the ECU 200 calculates the vehicle state and the braking force to control the first motor 300, to be described later, which is a hydraulic motor. Of course, additionally, the electric brake system may control an electronic parking brake (EPB), which provides parking braking power for a vehicle by controlling the second motor 400 to be described later. In other words, the brake system 10 may be a system that integrally controls electric brakes and electronic parking brakes.

To this end, the brake system 10 may include a power source 100, an ECU 200, a first motor 300, and a second motor 400. In this case, the first and second motors 300 and 400 may be three-phase motors operated by three-phase AC power.

The first motor 300 is a motor for operating the electric brake, and is a motor that operates to generate a braking pressure in accordance with the operation of the brake pedal in the vehicle. That is, driver's brake pedal operation amount may be transmitted as an electrical signal to drive the first motor 300, and the braking pressure may be generated according to the driving of the first motor 300. Of course, when the brake system 10 is mounted on a vehicle capable of autonomous driving, the first motor 300 may be driven according to the driving situation without the driver's brake pedal manipulation, and the braking pressure may be generated according to the operating of the first motor 300.

Meanwhile, the second motor 400 is a motor for operating an electronic parking brake (EPB). For example, the EPB may be a parking brake of the Motor on Caliper (MoC) type, but is not limited thereto.

The power source 100 supplies power having a first voltage that is a high voltage. That is, the power source 100 may supply DC power having the first voltage. In this case, the power source 100 may be a high-voltage battery. The first voltage is relatively high compared to a second voltage. For example, the first voltage may be 47V to 49V, or preferably 48V, but is not limited thereto.

The ECU 200 is a component that controls the operation of the brake system 10. In other words, the ECU 200 may control the operations of the first motor 300 and the second motor 400 to control the braking pressure and the operation of EPB according to the operation of the brake pedal. This ECU 200 may be differently referred to as a “control device.” Referring to FIGS. 2 to 5, the ECU 200 may include a main connector 201, a DC-DC converter 202, a controller 203, an inverter 204, an EPB driver 205, and a valve 206.

Of course, the ECU 200 includes lines for supplying DC power of the first or second voltage to the main connector 201, the DC-DC converter 202, the controller 203, the inverter 204, the EPB driver 205, and the valve 206, respectively. Hereinafter, a line through which the DC power of the first voltage is supplied is referred to as a “first power line,” and a line through which the DC power of the second voltage is supplied is referred to as a “second power line.” Of course, the first power line may be provided in plural, and the second power line may be provided in plural.

In this case, the power input units of the main connector 201, the DC-DC converter 202, and the inverter 204 may be connected to the first power line, respectively. The power input unit of the controller 203 may be connected to the second power line. The power inputs of the EPB driver 205 and the valve 206 may be connected to the first or second power lines, respectively. In addition, the power output unit of the main connector 201 may be connected to the first power line. The power output unit of the DC-DC converter 202 may be connected to the second power line.

In addition, the ECU 200 may also include lines for supplying control signals for controlling the inverter 204, the EPB driver 205, and the valve 206, respectively, by the controller 203. Hereinafter, a line through which a control signal is supplied from the controller 203 is referred to as a “control line.” That is, the control line may be provided between the controller 203 and the inverter 204, between the controller 203 and the EPB driver 205, and between the controller 203 and the valve 206, respectively.

The main connector 201 is a component that is connected to receive a DC power of a first voltage supplied from the power source 100 and distribute the DC power of the corresponding first voltage to a plurality of configurations within the ECU 200. That is, the main connector 201 may supply DC power of the input first voltage to at least one of the inverter 204, the DC-DC converter 202, the EPB driver 205, and the valve 206.

In particular, the main connector 201 may essentially supply DC power of the input first voltage to the inverter 204 and the DC-DC converter 202. Of course, the main connector 201 may selectively supply DC power of the input first voltage to the EPB driver 205 or the valve 206 according to the first to fourth embodiments to be described later. In this case, the selective supply of the DC power of the first voltage may mean that all the DC power of the first voltage is not supplied to the EPB driver 205 and the valve 206 (first embodiment), the DC power of the first voltage is supplied only to the driver 205 (second embodiment), the DC power of the first voltage is supplied only to the valve 206 (third embodiment), or the DC power of the first voltage is supplied to both the driver 205 and the valve 206 (fourth embodiment). Of course, DC power of a second voltage to be described later may be supplied to a component to which DC power of the first power source is not supplied.

The DC-DC converter 202 converts the DC power of the first voltage supplied through the main connector 201 into the DC power of the second voltage. At this time, the second voltage is relatively lower than the first voltage. For example, the second voltage may be 11V to 13V, or preferably 12V, but is not limited thereto. In other words, the DC-DC converter 202 may supply the DC power of the second voltage for the operation of the component that requires the DC power of the second voltage lower than the first voltage except for the inverter 204 in the ECU 200. Of course, the DC-DC converter 202 may also be simply referred to as a “converter 202.”

The controller 203 is a component that controls the operation of the ECU 200. That is, the controller 203 may control the operations of the first motor 300, the second motor 400, the DC-DC converter 202, and the valve 206. In this case, in order to control the first motor 300 and the second motor 400, the controller 203 may control the operation of the switching element of the inverter 204 and the EPB driver 205. In other words, in order to control the braking pressure according to the operation of the brake pedal of the vehicle, the controller 203 controls the first motor 300 by controlling the switching element of the inverter 204, and may control the operation of the valve 206. In addition, in order to control the operation according to the EPB, the controller 203 may control the operation of the switching element of the second motor 400. In addition, for control of the DC-DC converter 202, the controller 203 may control the operation of the switching element of the DC-DC converter 202.

The controller 203 may include a processor and a memory. For example, the controller 203 may include at least one Micro Controller Unit (MCU). In particular, it is preferable that the controller 203 operates by receiving the DC voltage of the second voltage converted by the DC-DC converter 202.

In the controller 203, the memory stores various kinds of information necessary for the operation of the brake system 10. In this case, the storage information of the memory may include various information for the control operation of the controller 203, but is not limited thereto. In addition, in the controller 203, the processor may perform various control operations for the brake system 10 using information stored in the memory.

For example, the memory may include a volatile memory element such as DRAM or SRAM, a non-volatile memory element such as PRAM, MRAM, ReRAM, or NAND flash memory, or a hard disk drive (HDD) or a solid state drive (SSD), but is not limited thereto. In addition, the memory may be a cache, a buffer, a main storage device, or an auxiliary storage device or a separately provided storage system depending on its purpose/location, but is not limited thereto.

The inverter 204 is a component that is disposed between the main connector 201 and the first motor 300, and inverts the DC power of the first voltage supplied through the main connector 201 into three-phase AC power and supplies it to the first motor 300. That is, since the first motor 300 is a three-phase motor, the inverter 204 may invert the DC power of the first voltage into an AC power that may drive the three-phase motor. The inverter 204 may be controlled by the controller 203.

For example, the inverter 204 may include a plurality of switching elements (e.g., FET, etc.) that operate under the control of the controller 203. In this case, the switching element of the inverter 204 may be implemented in plural (e.g., six). That is, by operating the plurality of switching elements of the inverter 204, the DC power of the first voltage is inverted into the three-phase AC power, and accordingly, each inverted AC power may be supplied to the U-phase, the V-phase, and the W-phase of the first motor 300.

The inverter 204 may be operated by an inverter control signal transmitted from the controller 203. That is, each switching element of the inverter 204 may perform an on/off operation by the inverter control signal. For example, the inverter control signal may be a signal in the form of pulse width modulation (PWM).

The EPB driver 205 is configured to operate the second motor 400 of the EPB that provides a parking braking force to maintain a parking state when parking the vehicle. To this end, the EPB driver 205 is disposed between the DC-DC converter 202 and the second motor 400 and inverts the DC power of the first voltage supplied through the main connector 201 or the DC power of the second voltage supplied through the DC-DC converter 202 into the three-phase AC power and supplies it to the second motor 400. In other words, the EPB driver 205 may perform an inverting function. In this case, since the second motor 400 is a three-phase motor, the EPB driver 205 may invert the DC power of the first voltage or the second voltage into the AC power capable of operating the three-phase motor. The EPB driver 205 may be controlled by the controller 203. Of course, the EPB driver 205 may also be simply referred to as a “driver 205.”

For example, the EPB driver 205 may include a plurality of switching elements (e.g., FET, etc.) that operate under control of the controller 203. However, the number of switching elements included in the EPB driver 205 is smaller than the number of switching elements included in the inverter 204. This is because the inverter 204 controls the AC voltage transmitted to the first motor 300 in more diverse types, while the EPB driver 205 controls the AC voltage transmitted to the second motor 400 in more simple types. In this case, the type of the AC voltage may refer to the type of peak voltage size that the AC voltage may have.

Accordingly, the number of switching elements included in the inverter 204 is smaller than the number of switching elements included in the EPB driver 205 for various types of control of the AC voltage. For example, a plurality of switching elements (e.g., four, etc.) included in the EPB driver 205 may be implemented in the form of an H-Bridge. By operating the switching element of the EPB driver 205, the DC power of the first voltage or the second voltage is inverted into three-phase AC power, and accordingly, the inverted AC power may be supplied to the U-phase, the V-phase, and the W-phase of the second motor 400.

The EPB driver 205 may operate by a control signal transmitted from the controller 203. At this time, each switching element of the EPB driver 205 may be turned on/off by the corresponding control signal. For example, the control signal may be a signal in the form of pulse width modulation (PWM).

However, the EPB driver 205 may not be included in the ECU 200. In this case, the EPB driver 205 may be a component included in the brake system 10 such as the first motor 300 and the second motor 400 and may be a component provided outside the ECU 200. Accordingly, the ECU 200 may include a first or second power line for providing the DC power of the first or second voltage to the EPB driver 205.

The valve 206 is configured to regulate the flow of braking hydraulic pressure generated according to the operation of the first motor 300. A plurality of valves 206 may be disposed in a hydraulic circuit through which the generated braking hydraulic pressure flows. To this end, the valve 206 may operate by receiving the DC power of the first voltage supplied through the main connector 201 or the DC power of the second voltage supplied through the DC-DC converter 202. For example, the valve 206 may be a solenoid valve, but is not limited thereto. These valves 206 may be controlled by the controller 203. That is, the controller 203 may transmit a control signal to the valve 206 for controlling the valve 206.

However, the valve 206 may not be included in the ECU 200. In this case, the valve 206 may be a component included in the brake system 10 such as the first motor 300 and the second motor 400 and may be a component provided outside the ECU 200. Accordingly, the ECU 200 may include a first or second power line for providing the DC power of the first or second voltage to the valve 206. Of course, the ECU 200 may also include a control line for a control signal for the valve 206 by the controller 203.

The brake system 10 configured as described above may be divided into first to fourth embodiments according to the power connection structure for the components of the ECU 200. Hereinafter, these first to fourth embodiments will be described.

First, referring to FIG. 2, in the EPB 200A of the brake system 10A according to the first embodiment of the present disclosure, DC power of the first voltage supplied through the main connector 201 may be supplied to the inverter 204 and the DC-DC converter 202, respectively. On the other hand, DC power of the second voltage converted and supplied from the DC-DC converter 202 may be supplied to the controller 203, the EPB driver 205, and the valve 206, respectively. Accordingly, a first power line may be provided between the main connector 201 and the inverter 204 and between the main connector 201 and the DC-DC converter 202, respectively. In addition, a second power line may be provided between the DC-DC converter 202 and the controller 203, between the DC-DC converter 202 and the EPB driver 205, and between the DC-DC converter 202 and the valve 206, respectively.

Next, referring to FIG. 3, in the EPB 200B of the brake system 10B according to the second embodiment of the present disclosure, DC power of the first voltage supplied through the main connector 201 may be supplied to the inverter 204, the DC-DC converter 202, and the EPB driver 205, respectively. On the other hand, DC power of the second voltage converted and supplied from the DC-DC converter 202 may be supplied to the controller 203 and the valve 206, respectively. Accordingly, a first power line may be provided between the main connector 201 and the inverter 204, between the main connector 201 and the DC-DC converter 202, and between the main connector 201 and the EPB driver 205, respectively. In addition, a second power line may be provided between the DC-DC converter 202 and the controller 203 and between the DC-DC converter 202 and the valve 206, respectively.

Next, referring to FIG. 4, in the EPB 200C of the brake system 10C according to the third embodiment of the present disclosure, DC power of the first voltage supplied through the main connector 201 may be supplied to the inverter 204, the DC-DC converter 202, and the valve 206, respectively. On the other hand, DC power of the second voltage converted and supplied from the DC-DC converter 202 may be supplied to the controller 203 and the EPB driver 205, respectively. Accordingly, a first power line may be provided between the main connector 201 and the inverter 204, between the main connector 201 and the DC-DC converter 202, and between the main connector 201 and the valve 206, respectively. In addition, a second power line may be provided between the DC-DC converter 202 and the controller 203 and between the DC-DC converter 202 and the EPB driver 205, respectively.

Next, referring to FIG. 5, in the EPB 200D of the brake system 10D according to the fourth embodiment of the present disclosure, DC power of the first voltage supplied through the main connector 201 may be supplied to the inverter 204, the DC-DC converter 202, the EPB driver 205, and the valve 206, respectively. On the other hand, DC power of the second voltage converted and supplied from the DC-DC converter 202 may be supplied only to the controller 203. Accordingly, a first power line may be provided between the main connector 201 and the inverter 204, between the main connector 201 and the DC-DC converter 202, between the main connector 201 and the EPB driver 205, and between the main connector 201 and the valve 206, respectively. Also, a second power line may be provided between the DC-DC converter 202 and the controller 203.

FIG. 6 shows an example of a circuit of a DC-DC converter 202.

The DC-DC converter 202 may convert DC power of the first voltage V1 supplied through the main connector 201 into DC power of the second voltage V2. To this end, the DC-DC converter 202 may include an inductor L, a switching element Q, and a capacitor C, as shown in FIG. 6. In this case, the switching element Q may be a field effect transistor (FET), and control of the switching element Q may be performed by the controller 203. That is, the switching element Q may be turned on/off according to the control signal of the controller 203.

Specifically, when the switching element Q is turned on, the second voltage V2 may be transferred to the output side of the DC-DC converter 202 while the current supplied according to the first voltage V1 passes through the inductor L and the capacitor C performing the smoothing operation is charged with the second voltage V2. Accordingly, the DC power of the first voltage V1 may be converted into the DC power of the second voltage V2. In this case, the current flowing through the inductor L generates a magnetic field, and electrical energy is converted into magnetic energy and accumulated. After that, when the switching element Q is turned off, energy accumulated in the inductor L may be discharged to the output side and the second voltage V2 may be transferred to the output side of the DC-DC converter 202.

In particular, according to the first to fourth embodiments, the capacities of the inductor L and the switching element Q of the DC-DC converter 202 should be appropriately designed. This is because the components (loads) connected to the output side of the DC-DC converter 202 vary according to the first to fourth embodiments, and thus the maximum current to be supplied through the DC-DC converter 202 varies according to the first to fourth embodiments.

In a case of the first embodiment, the current of the DC power converted through the DC-DC converter 202 should be supplied to the controller 203, the EPB driver 205, and the valve 206, respectively. In the first embodiment, since the current of the converted DC power of the DC-DC converter 202 should be supplied to the largest load, the largest maximum current among the first to fourth embodiments should be supplied through the DC-DC converter 202. For example, when the first voltage V1 is 47V to 49V (e.g., 48V) and the second voltage V2 is 11V to 13V (e.g., 12V), the maximum current supplied through the DC-DC converter 202 should be approximately 38 A to 42 A (e.g., 40 A). That is, in this case, the inductor L and the switching element Q of the DC-DC converter 202 are preferably designed to have a capacity capable of allowing a current of up to 38 A to 42 A (e.g., 40 a).

In a case of the second embodiment, the current of the DC power converted through the DC-DC converter 202 should be supplied to the controller 203 and the valve 206, respectively. In addition, in the third embodiment, the current of the DC power converted through the DC-DC converter 202 should be supplied to the controller 203 and the EPB driver 205, respectively. In the second and third embodiments, the current of the converted DC power of the DC-DC converter 202 should be supplied to a relatively smaller load than in the first embodiment, so that a maximum current smaller than that of the first embodiment should be supplied through the DC-DC converter 202. For example, when the first voltage V1 is 47V to 49V (e.g., 48V) and the second voltage V2 is 11V to 13V (e.g., 12V), the maximum current supplied through the DC-DC converter 202 should be approximately 28 A to 32 A (e.g., 30 A). That is, in this case, the inductor L and the switching element Q of the DC-DC converter 202 are preferably designed to have a capacity capable of allowing a current of up to 28 A to 32 A (e.g., 30 A).

In a case of the fourth embodiment, the current of the DC power converted through the DC-DC converter 202 should be supplied to the controller 203. In the fourth embodiment, since the current of the converted DC power of the DC-DC converter 202 should be supplied to the smallest load, the smallest maximum current among the first to fourth embodiments should be supplied through the DC-DC converter 202. For example, when the first voltage V1 is 47V to 49V (e.g., 48V) and the second voltage V2 is 11V to 13V (e.g., 12V), the maximum current supplied through the DC-DC converter 202 should be approximately 4 A to 6 A (e.g., 5 a). That is, in this case, the inductor L and the switching element Q of the DC-DC converter 202 are preferably designed to have a capacity capable of allowing a current of up to 4 A to 6 A (e.g., 5 A).

In particular, in the first to fourth embodiments, the inductor L and the switching element Q should be designed to allow each given maximum current range. When designed to allow a capacity lower than the corresponding maximum current, failure may occur in the inductor L and the switching element Q. On the other hand, when designed to allow a capacity higher than the corresponding maximum current, the inductor L and the switching element Q may unnecessarily increase in volume and cost.

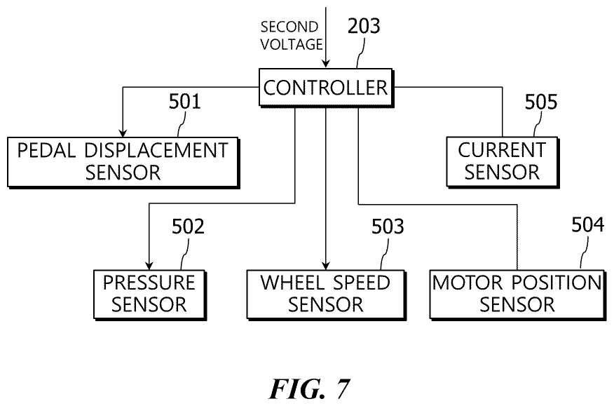

FIG. 7 shows an example of an additional configuration in which power is supplied through the controller 203 in the brake system 10 according to the embodiments of the present disclosure.

Meanwhile, the brake system 10 may further include a pedal displacement sensor 501, a pressure sensor 502, a wheel speed sensor 503, a motor position sensor 504 and a current sensor 505. At this case, the controller 203 may supply DC power to the pedal displacement sensor 501, the pressure sensor 502, and the wheel speed sensor 503. Of course, the controller 203 may receive pedal displacement information from the pedal displacement sensor 501, receive braking pressure information from the pressure sensor 502, receive wheel speed information from the wheel speed sensor 503, receive position information of the first motor 300 from the motor position sensor 504, and receive current information of the first motor 300 from the current sensor 505.

The pedal displacement sensor 501 detects the displacement of the brake pedal of the vehicle. For example, the pedal displacement sensor 501 may detect at least one of an angle or a moving distance of the brake pedal. The pedal displacement information detected by the pedal displacement sensor 501 may be utilized by the controller 203 to control the first motor 300. That is, in accordance with the pedal displacement information detected by the pedal displacement sensor 501, the controller 203 may control the switching element of the inverter 204 to control the AC power supplied to the first motor 300.

The pedal displacement sensor 501 may be controlled by the controller 203. In particular, the controller 203 may supply power to the pedal displacement sensor 501. For example, the controller 203 may supply DC power of the second voltage to the pedal displacement sensor 501. In addition, the controller 203 may receive pedal displacement information from the pedal displacement sensor 501.

The pressure sensor 502 detects the braking pressure supplied to the wheel of the vehicle. For example, the pressure sensor 502 may detect the braking pressure supplied to the wheel side of the vehicle so that the brake pad pressurizes the disk. The braking pressure information detected by the pressure sensor 502 may be utilized by the controller 203 to control the first motor 300.

The pressure sensor 502 may be controlled by the controller 203. In particular, the controller 203 may supply power to the pressure sensor 502. For example, the controller 203 may supply DC power of the second voltage to the pressure sensor 502. In addition, the controller 203 may receive braking pressure information from the pressure sensor 502.

The wheel speed sensor 503 detects the wheel speed of the vehicle. The wheel speed sensor 503 may be disposed on each of a plurality of wheels of the vehicle. The wheel speed information detected by the wheel speed sensor 503 may be utilized as one of the variables for the controller 203 to control the first motor 300.

The wheel speed sensor 503 may be controlled by the controller 203. In particular, the controller 203 may supply power to the wheel speed sensor 503. For example, the controller 203 may supply DC power of the second voltage to the wheel speed sensor 503. In addition, the controller 203 may receive wheel speed information from the wheel speed sensor 503.

The motor position sensor 504 detects the position of first motor 300. The motor position information detected by the motor position sensor 504 may be utilized for control of the first motor 300. The motor position sensor 504 may transmit motor position information to controller 203.

The current sensor 505 detects the current of the first motor 300. The motor current information detected by the current sensor 505 may be utilized for the control of the first motor 300. The current sensor 505 may transmit the motor current information to the controller 203.

However, as shown in FIG. 7, instead of supplying DC power to the pedal displacement sensor 501, the pressure sensor 502, and the wheel speed sensor 503 through the controller 203, the output of the DC-DC converter 202 may be connected to the pedal displacement sensor 501, the pressure sensor 502, and the wheel speed sensor 503, so that the DC power may be respectively supplied. In this case, the DC power of the second voltage converted by the DC-DC converter 202 may be supplied to the pedal displacement sensor 501, the pressure sensor 502, and the wheel speed sensor 503, respectively.

The present disclosure configured as described above has the advantage of achieving both the efficiency of power source use and the economic feasibility of circuit configuration for the ECU 200 by adopting the power of the first voltage, which is a high-voltage, as the driving power of the first motor in the ECU 200 of the brake system 10, and selectively adopting the power of the first voltage or the power of the second voltage, which is lower than the first voltage, as the driving power for the remaining configurations of the ECU 200. In particular, as the power connection technology for the first and second voltages is implemented inside the ECU 200, the wiring for the power is reduced by up to ¼ than the power connection technology for the first and second voltages is implemented outside the ECU 200, so that the cost reduction effect is great.

Although the present disclosure has been described in detail with reference to specific embodiments, it is to be understood that various modifications are possible without departing from the scope of the present disclosure. Therefore, the scope of the present disclosure is not limited to the described embodiments.

1. An electronic control unit (ECU) for an electric brake system including a first motor operating to generate a braking pressure in a vehicle, a valve adjusting a braking hydraulic pressure according to the operation of the first motor, a second motor operating to provide a parking braking force for the vehicle, and a driver supplying AC power for the operation of the second motor,
the ECU comprising:
a converter configured to convert DC power of a first voltage into DC power of a second voltage that is lower than the first voltage;
an inverter configured to invert the DC power of the first voltage into AC power and supply the AC power to the first motor; and
a controller configured to receive the DC power of the second voltage and control at least one of the inverter, the valve, and the driver, and
the ECU further comprises a first power line or a second power line,
wherein the first power line supplies the DC power of the first voltage, and
wherein the second power line supplies the DC power of the second voltage to at least one of the driver and the valve.

2. The ECU of claim 1, wherein the driver and the valve are connected to the second power line and operate by receiving the DC power of the second voltage.

3. The ECU of claim 1, wherein the driver is connected to the first power line and operates by receiving the DC power of the first voltage, and
the valve is connected to the second power line and operates by receiving the DC power of the second voltage.

4. The ECU of claim 1, wherein the valve is connected to the first power line and operates by receiving the DC power of the first voltage, and
the driver is connected to the second power line and operates by receiving the DC power of the second voltage.

5. The ECU of claim 1, wherein the driver and the valve are connected to the first power line and operate by receiving the DC power of the first voltage.

6. The ECU of claim 1, wherein the inverter and the driver each include a plurality of switching elements for performing inversion of the DC power to AC power,
wherein the inverter includes a larger number of switching elements than the driver, and
wherein the AC voltage transmitted to the first motor through the inverter has relatively more types of peak voltage sizes than the AC voltage transmitted to the second motor through the driver.

7. The ECU of claim 2, wherein when the first voltage is 47V to 49V and the second voltage is 11V to 13V, a maximum current converted and supplied through the converter is 38 A to 42 A.

8. The ECU of claim 3, wherein when the first voltage is 47V to 49V and the second voltage is 11V to 13V, a maximum current converted and supplied through the converter is 28 A to 32 A.

9. The ECU of claim 5, wherein when the first voltage is 47V to 49V and the second voltage is 11V to 13V, a maximum current converted and supplied through the converter is 4 A to 6 A.

10. The ECU of claim 1, wherein the electric brake system further comprises a pedal displacement sensor, a pressure sensor, and a wheel speed sensor, and
the controller is configured to control the inverter using pedal displacement information received from the pedal displacement sensor, braking pressure information received from the pressure sensor, and wheel speed information received from the wheel speed sensor, respectively.

11. An electric brake system comprising:
a power source configured to supply DC power of a first voltage;
a first motor configured to generate a braking pressure in a vehicle;
a valve configured to adjust a braking hydraulic pressure according to an operation of the first motor;
a second motor configured to provide a parking braking force for the vehicle;
a driver configured to supply AC power for operation of the second motor; and
an electronic control unit (ECU) configured to control the operations of the first and second motors,
wherein the ECU comprises:
a converter configured to convert the DC power of the first voltage into DC power of a second voltage that is lower than the first voltage;
an inverter configured to invert the DC power of the first voltage into AC power and supply the AC power to the first motor; and
a controller configured to receive the DC power of the second voltage and control at least one of the inverter, the valve, and the driver,
wherein at least one of the driver and the valve is configured to receive the DC power of the first voltage or the DC power of the second voltage and operate.

12. The electric brake system of claim 11, wherein the driver and the valve operate by receiving the DC power of the second voltage.

13. The electric brake system of claim 11, wherein the driver operates by receiving the DC power of the first voltage, and
the valve operates by receiving the DC power of the second voltage.

14. The electric brake system of claim 11, wherein the valve operates by receiving the DC power of the first voltage, and
the driver operates by receiving the DC power of the second voltage.

15. The electric brake system of claim 11, wherein the driver and the valve operate by receiving the DC power of the first voltage.

16. The electric brake system according to claim 11,
wherein the inverter and the driver each include a plurality of switching elements for performing inversion to the AC power,
wherein the inverter includes a larger number of switching elements than the driver, and
wherein the AC voltage transmitted to the first motor through the inverter has relatively more types of peak voltage sizes than the AC voltage transmitted to the second motor through the driver.

17. The electric brake system of claim 12, wherein when the first voltage is 47V to 49V and the second voltage is 11V to 13V, a maximum current converted and supplied through the converter is 38 A to 42 A.

18. The electric brake system of claim 13, wherein when the first voltage is 47V to 49V and the second voltage is 11V to 13V, a maximum current converted and supplied through the converter is 28 A to 32 A.

19. The electric brake system of claim 15, wherein when the first voltage is 47V to 49V and the second voltage is 11V to 13V, a maximum current converted and supplied through the converter is 4 A to 6 A.

20. A vehicle comprising:
a body having at least one motor mounted therein;
an electric brake system connected to the body, the electric brake system comprising:
a power source configured to supply DC power of a first voltage;
a first motor configured to generate a braking pressure in the vehicle;
a valve configured to adjust a braking hydraulic pressure according to an operation of the first motor;
a second motor configured to provide a parking braking force for the vehicle;
a driver configured to supply AC power for operation of the second motor; and
an electronic control unit (ECU) controlling the operations of the first and second motors,
wherein the ECU comprises:
a converter configured to convert the DC power of the first voltage into DC power of a second voltage that is lower than the first voltage;
an inverter configured to invert the DC power of the first voltage into AC power and supply the AC power to the first motor; and
a controller configured to receive the DC power of the second voltage and control at least one of the inverter, the valve, and the driver,
wherein at least one of the driver and the valve is configured to receive the DC power of the first voltage or the DC power of the second voltage and operate.
